(19) United States
(12) Patent Application Publication
(10) Pub. No.: US 2020/0072188 A1
(43) Pub. Date: Mar. 5, 2020

(54) Counterweight Assembly for Use During Single Blade Installation of a Wind Turbine

(71) Applicant: General Electric Company, Schenectady, NY (US)

(72) Inventors: Ulrich Werner Neumann, Simpsonville, SC (US); Ganesh Dashrath Raut, Bangalore (IN)

(21) Appl. No.: 16/118,600

(22) Filed: Aug. 31, 2018

(51) Int. Cl. F03D 1/06; F03D 13/10

(52) U.S. Cl. CPC F03D 1/0658; F05B 2230/61; F03D 13/10

(57) ABSTRACT

A method for installing a plurality of rotor blades to a rotatable hub secured atop a tower of a wind turbine includes providing a counterweight assembly having, at least, an arm member and a counterweight mass secured at a distal end of the mounting assembly. The method also includes securing the arm member of the counterweight assembly to the hub of the wind turbine. Further, the method includes consecutively installing the plurality of rotor blades onto the hub of the wind turbine. Moreover, the method includes rotating the arm member about a rotation axis of the hub to continuously adjust a position of the counterweight mass between each consecutive installation of the plurality of rotor blades to change a center of gravity of the hub and maintain a balanced rotor of the wind turbine during installation of the plurality of rotor blades.

### FIELD

The present disclosure relates generally to wind turbines, and more particularly to a counterweight assembly for use during single blade installation of a wind turbine.

### BACKGROUND

Wind power is considered one of the cleanest, most environmentally friendly energy sources presently available, and wind turbines have gained increased attention in this regard. A modern wind turbine typically includes a tower, generator, gearbox, nacelle, and one or more rotor blades. The rotor blades capture kinetic energy of wind using known airfoil principles. The rotor blades transmit the kinetic energy in the form of rotational energy so as to turn a shaft coupling the rotor blades to a gearbox, or if a gearbox is not used, directly to the generator. The generator then converts the mechanical energy to electrical energy that may be deployed to a utility grid.

Typically, to initially install a rotor blade onto the wind turbine hub, a significantly large crane must be transported to the wind turbine site in order to provide a means for raising the rotor blade relative to the hub. Unfortunately, it is often extremely expensive to both transport the crane to the wind turbine site and operate the crane for the amount of time necessary to install the rotor blade(s). As a result, the costs of employing such large cranes currently accounts for a significant portion of the overall costs associated with initial wind turbine installations.

In addition, as wind turbines continue to increase in size, cranes having the capacity to lift a fully-assembled rotor to certain tower heights are often unavailable in certain geographic locations. Therefore, in such locations, a single blade installation (SBI) process is required. In the SBI process, the hub and rotor blades are installed atop the tower sequentially in consecutive lifts. More specifically, an unbalanced rotor turning gear (URTG) drive is typically installed on the backside of the main gearbox which meshes with the teeth on the brake disc. One or more cranes then lift the hub atop the tower so that the hub can be secured to the nacelle. The entire drivetrain is then rotated using the URTG drive such that a first axis of the hub is positioned horizontally and a rotor lock is applied. A first rotor blade can then be installed in a horizontal position. After the first rotor blade is secured and the crane(s) have released the blade, the URTG device is used to rotate the hub through 120° so that the next rotor blade can be installed. This process is repeated until all rotor blades have been installed.

During the SBI process, however, the static and aerodynamic load of the unbalanced rotor (e.g. when only one or two rotor blades have been installed) may exceed capacity of the Unbalanced Rotor Turning Gear. For example, the highest static load on the drivetrain typically occurs when there is only one rotor blade positioned horizontally or two rotor blades in a “sideways-V” position.

Accordingly, improved methods and related systems the SBI process that utilizes a counterweight assembly to address the aforementioned issues would be welcomed in the art.

### BRIEF DESCRIPTION

Aspects and advantages of the invention will be set forth in part in the following description, or may be obvious from the description, or may be learned through practice of the invention.

In one aspect, the present disclosure is directed to a method for installing a plurality of rotor blades to a rotatable hub secured atop a tower of a wind turbine. The method includes providing a counterweight assembly having, at least, an arm member and a counterweight mass secured at a distal end of the mounting assembly. The method also includes securing the arm member of the counterweight assembly to the hub of the wind turbine. Further, the method includes consecutively installing the plurality of rotor blades onto the hub of the wind turbine. Moreover, the method includes rotating the arm member about a rotation axis of the hub to continuously adjust a position of the counterweight mass between each consecutive installation of the plurality of rotor blades to change a center of gravity of the hub and maintain a balanced rotor of the wind turbine during installation of the plurality of rotor blades.

In one embodiment, the step of rotating the arm member about the rotation axis of the hub to continuously adjust the position of the counterweight mass may include affixing an outer race of a slewing ring bearing to the hub and allowing an inner race of the slewing ring bearing to rotate with respect to the outer race and mounting the arm member to the inner race of the slewing ring bearing. As such, rotation of the inner race of the slewing ring bearing allows for rotation of the arm member and the counterweight mass. In another embodiment, the inner race of the slewing ring bearing may include gear teeth that mesh with a drive mechanism. Thus, the drive mechanism is configured to drive rotation of the inner race with respect to the outer race.

In further embodiments, the method may include affixing the outer race of the slewing ring bearing to a front, exterior location of the hub. In additional embodiments, the counterweight mass may be initially suspended in a six o'clock position. In such embodiments, the drive mechanism is configured to rotate the arm member from the six o'clock position to any position around the inner race of the slewing ring bearing. In several embodiments, the method may also include locking the counterweight mass in a predetermined position via the drive mechanism.

In particular embodiments, the counterweight mass may include, at least in part, a reservoir filled at least partially with a fluid. In such embodiments, the method may further include varying an amount of the fluid in the reservoir to vary the weight of the counterweight mass. More specifically, in one embodiment, the step of varying the amount of the fluid in the reservoir may include pumping in or draining out the fluid from the reservoir via at least one conduit that extends from the reservoir through the arm member and into the hub.

In another embodiment, the method may include monitoring a moment and/or torque exerted onto the hub via at least one sensor (such as a strain gauge) mounted on the arm member and controlling the amount of fluid in the reservoir based on the moment and/or torque. In such embodiments, the sensor(s) is configured to continuously monitor the actual moment and/or torque exerted onto the hub, i.e. zero in the 6 o'clock position and maximum in the 3- or 9 o'clock position. In further embodiments, the method may also include monitoring the amount of the fluid pumped into the reservoir via at least one of a fill-level sight glass or a water meter.

In another aspect, the present disclosure is directed to a counterweight assembly for maintaining balance of a rotor of a wind turbine during installation of a plurality of rotor blades onto a rotatable hub secured atop a tower of the wind turbine. The counterweight assembly includes a counterweight mass configured to be moved to multiple positions between consecutive installations of the plurality of rotor blades to continuously change a center of gravity of the hub and maintain balance of the rotor during installation of the plurality of rotor blades. In addition, the counterweight assembly includes a rotatable arm member comprising a proximal end and a distal end. Further, the counterweight mass is secured at the distal end such that, when the arm member is secured to the hub, the counterweight mass remains spaced apart a predetermined distance from the hub, the proximal end configured for affixing the arm member at a front, exterior location of the hub forward of the plurality of rotor blades. As such, the rotatable arm member is configured to rotate about a rotation axis of the hub to continuously adjust a position of the counterweight mass between consecutive installations of the plurality of rotor blades to change a center of gravity of the hub and maintain a balanced rotor of the wind turbine during installation of the plurality of rotor blades. It should be understood that the counterweight assembly may further include any of the additional features and/or embodiments described herein.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a perspective view of a wind turbine according to one embodiment of the present disclosure;

FIG. 2 illustrates a perspective, internal view of one embodiment of a nacelle of a wind turbine according to the present disclosure;

FIG. 3 illustrates a perspective view of one embodiment of a rotor blade according to the present disclosure;

FIG. 4 illustrates a flow diagram of one embodiment of a method for installing a plurality of rotor blades to a rotatable hub secured atop a tower of a wind turbine according to the present disclosure;

FIG. 5 illustrates a perspective view of one embodiment of hub of a wind turbine according to the present disclosure, particularly illustrating a counterweight assembly mounted to the hub before any of the rotor blades have been installed thereto;

FIG. 6 illustrates a schematic diagram of one embodiment of hub of a wind turbine according to the present disclosure, particularly illustrating a counterweight assembly and a first rotor blade mounted to the hub;

FIG. 7 illustrates a schematic diagram of one embodiment of hub of a wind turbine according to the present disclosure, particularly illustrating a counterweight assembly mounted to the hub with first and second rotor blades being installed to the hub;

FIG. 8 illustrates a schematic diagram of one embodiment of hub of a wind turbine according to the present disclosure, particularly illustrating a counterweight assembly mounted to the hub and being rotated to offset the weight of first and second rotor blades before a third rotor blade is installed;

FIG. 9 illustrates a schematic diagram of one embodiment of hub of a wind turbine according to the present disclosure, particularly illustrating a counterweight assembly mounted to the hub and offsetting the weight of first and second rotor blades before a third rotor blade is installed;

FIG. 10 illustrates a schematic diagram of one embodiment of hub of a wind turbine according to the present disclosure, particularly illustrating a counterweight assembly mounted to the hub and offsetting the weight of first and second rotor blades while a third rotor blade is being installed to the hub; and

FIG. 11 illustrates a schematic diagram of one embodiment of hub of a wind turbine according to the present disclosure, particularly illustrating a counterweight assembly being removed from the hub after the rotor blades have been installed to the hub.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

Generally, the present subject matter is directed to various methods for consecutively installing a plurality of rotor blades to a rotatable hub secured atop a tower of a wind turbine. Specifically, as will become apparent from the description provided below, the disclosed methods utilize a counterweight assembly that can change the center of gravity of the rotor of the wind turbine in order to drive the rotor forward without putting new demands on components.

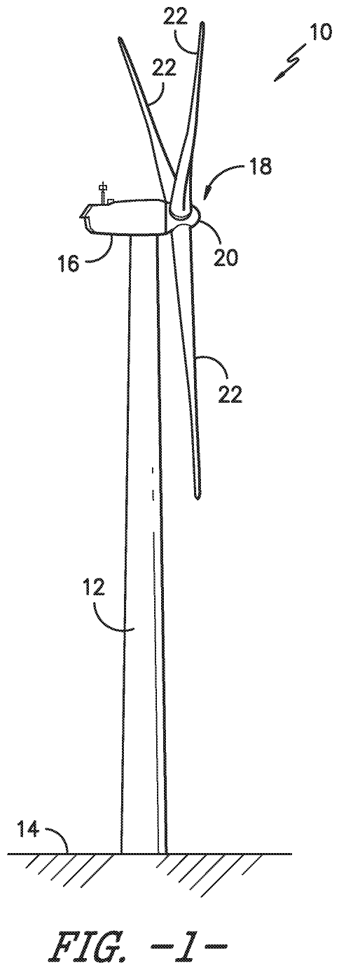

Referring now to the drawings, FIG. 1 illustrates a side view of one embodiment of a wind turbine 10 according to the present disclosure. As shown, the wind turbine 10 generally includes a tower 12 extending from a support surface 14 (e.g., the ground, a concrete pad or any other suitable support surface). In addition, the wind turbine 10 may also include a nacelle 16 mounted on the tower 12 and a rotor 18 coupled to the nacelle 16. The rotor 18 includes a rotatable hub 20 and at least one rotor blade 22 coupled to and extending outwardly from the hub 20. For example, in the illustrated embodiment, the rotor 18 includes three rotor blades 22. However, in an alternative embodiment, the rotor 19 may include more or less than three rotor blades 22. Each rotor blade 22 may be spaced about the hub 20 to facilitate rotating the rotor 19 to enable kinetic energy to be transferred from the wind into usable mechanical energy, and subsequently, electrical energy. For instance, the hub 20 may be rotatably coupled to an electric generator (not shown) positioned within the nacelle 16 to permit electrical energy to be produced.

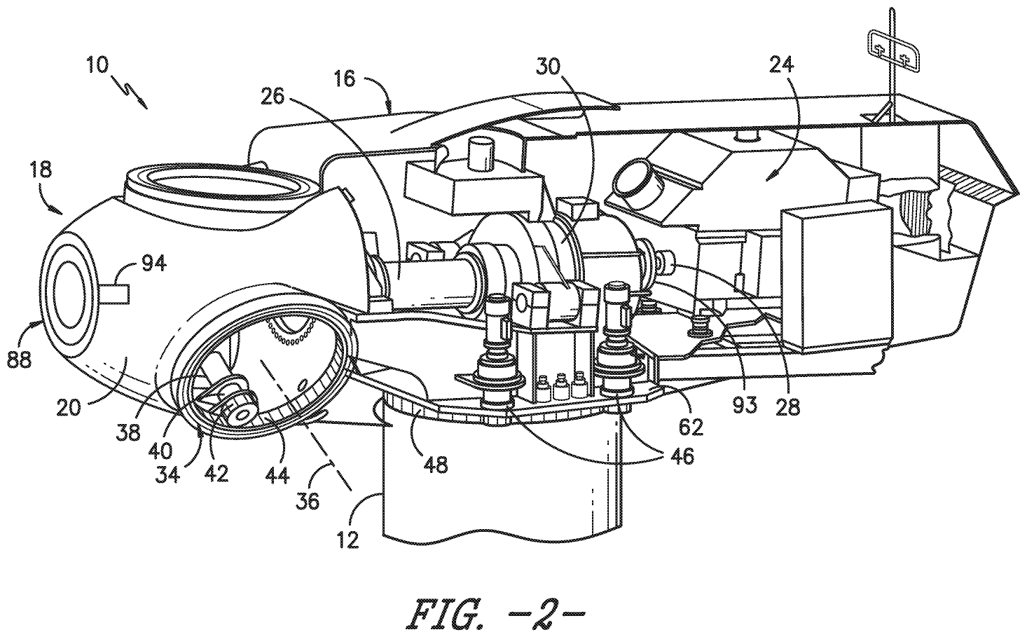

Referring now to FIG. 2, a simplified, internal view of one embodiment of the nacelle 16 of the wind turbine 10 is illustrated. As shown, a generator 24 may be disposed within the nacelle 16. In general, the generator 24 may be coupled to the rotor 18 of the wind turbine 10 for generating electrical power from the rotational energy generated by the rotor 18. For example, the rotor 18 may include a main shaft 26 coupled to the hub 20 for rotation therewith. The generator 24 may then be coupled to the main shaft 26 such that rotation of the main shaft 26 drives the generator 24. For instance, in the illustrated embodiment, the generator 24 includes a generator shaft 28 rotatably coupled to the main shaft 26 through a gearbox 40. However, in other embodiments, it should be appreciated that the generator shaft 28 may be rotatably coupled directly to the main shaft 26. Alternatively, the generator 24 may be directly rotatably coupled to the main shaft 26. In addition, as shown, it should be appreciated that the main shaft 26 may generally be supported within the nacelle 16 by a support frame or bedplate 62 positioned atop the wind turbine tower 12.

Each rotor blade 22 may also include a pitch adjustment mechanism 34 configured to rotate each rotor blade 22 about its pitch axis 36. Further, each pitch adjustment mechanism 34 may include a pitch drive motor 38 (e.g., any suitable electric, hydraulic, or pneumatic motor), a pitch drive gearbox 40, and a pitch drive pinion 42. In such embodiments, the pitch drive motor 38 may be coupled to the pitch drive gearbox 40 so that the pitch drive motor 38 imparts mechanical force to the pitch drive gearbox 40. Similarly, the pitch drive gearbox 40 may be coupled to the pitch drive pinion 42 for rotation therewith. The pitch drive pinion 42 may, in turn, be in rotational engagement with a pitch bearing 44 coupled between the hub 20 and a corresponding rotor blade 22 such that rotation of the pitch drive pinion 42 causes rotation of the pitch bearing 44. Thus, in such embodiments, rotation of the pitch drive motor 38 drives the pitch drive gearbox 40 and the pitch drive pinion 42, thereby rotating the pitch bearing 44 and the rotor blade 22 about the pitch axis 36. Similarly, the wind turbine 10 may include one or more yaw drive mechanisms 46 configured to change the angle of the nacelle 16 relative to the wind (e.g., by engaging a yaw bearing 48 of the wind turbine 10).

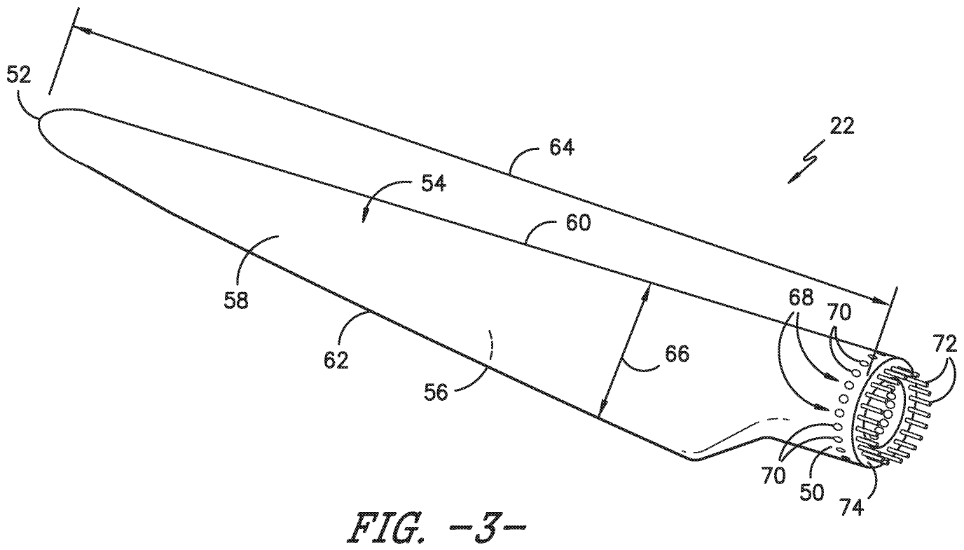

Referring now to FIG. 3, a perspective view of one of the rotor blades 22 shown in FIG. 1 is illustrated in accordance with aspects of the present subject matter. As shown, the rotor blade 22 includes a blade root 50 configured for mounting the rotor blade 22 to the hub 20 of a wind turbine 10 (FIG. 1) and a blade tip 52 disposed opposite the blade root 50. A body 54 of the rotor blade 22 may extend lengthwise between the blade root 50 and the blade tip 52 and may generally serve as the outer shell of the rotor blade 22. As is generally understood, the body 54 may define an aerodynamic profile (e.g., by defining an airfoil shaped cross-section, such as a symmetrical or cambered airfoil-shaped cross-section) to enable the rotor blade 22 to capture kinetic energy from the wind using known aerodynamic principles. Thus, the body 54 may generally include a pressure side 56 and a suction side 58 extending between a leading edge 60 and a trailing edge 62. Additionally, the rotor blade 22 may have a span 64 defining the total length of the body 54 between the blade root 50 and the blade tip 52 and a chord 66 defining the total length of the body 54 between the leading edge 60 and the trailing edge 62. As is generally understood, the chord 66 may vary in length with respect to the span 64 as the body 54 extends from the blade root 50 to the blade tip 52.

Moreover, as shown in FIG. 3, the rotor blade 22 may also include a plurality of T-bolts or root attachment assemblies 68 for coupling the blade root 22 to the hub 20 of the wind turbine 10. In general, each root attachment assembly 68 may include a barrel nut 70 mounted within a portion of the blade root 50 and a root bolt 72 coupled to and extending from the barrel nut 70 so as to project outwardly from a root end 74 of the blade root 50. By projecting outwardly from the root end 74, the root bolts 72 may generally be used to couple the blade root 50 to the hub 20 via one of the pitch bearings 44 (FIG. 2) of the wind turbine 10. For example, the pitch bearing 44 may define a plurality of bolt holes (not shown) configured to receive the root bolts 72.

Referring now to FIG. 4, a flow diagram of one embodiment of a method 100 for installing a plurality of rotor blades to a rotatable hub secured atop a tower of a wind turbine is illustrated. In general, the method 100 will be described herein with reference to the wind turbine and rotor blades 22 shown in FIGS. 1-3. However, it should be appreciated that the disclosed method 100 may be implemented with any wind turbine having any other suitable configurations. In addition, although FIG. 4 depicts steps performed in a particular order for purposes of illustration and discussion, the methods discussed herein are not limited to any particular order or arrangement. One skilled in the art, using the disclosures provided herein, will appreciate that various steps of the methods disclosed herein can be omitted, rearranged, combined, and/or adapted in various ways without deviating from the scope of the present disclosure.

As shown at 102, the method 100 includes providing a counterweight assembly 80 having, at least, an arm member 84 and a counterweight mass 86 secured at a distal end of the arm member 84. As shown at 104, the method 100 may include securing the arm member 84 of the counterweight assembly 80 to the hub 20 of the wind turbine 10. As shown at 106, the method 100 may include consecutively installing the plurality of rotor blades 22 onto the hub 20 of the wind turbine 10. As shown at 108, the method 100 may include rotating the arm member 84 about a rotation axis of the hub 20 to continuously adjust a position of the counterweight mass 86 between each consecutive installation of the rotor blades 22 to change a center of gravity 82 of the hub 20 and maintain a balanced rotor 18 of the wind turbine 10 during installation of the rotor blades 22.

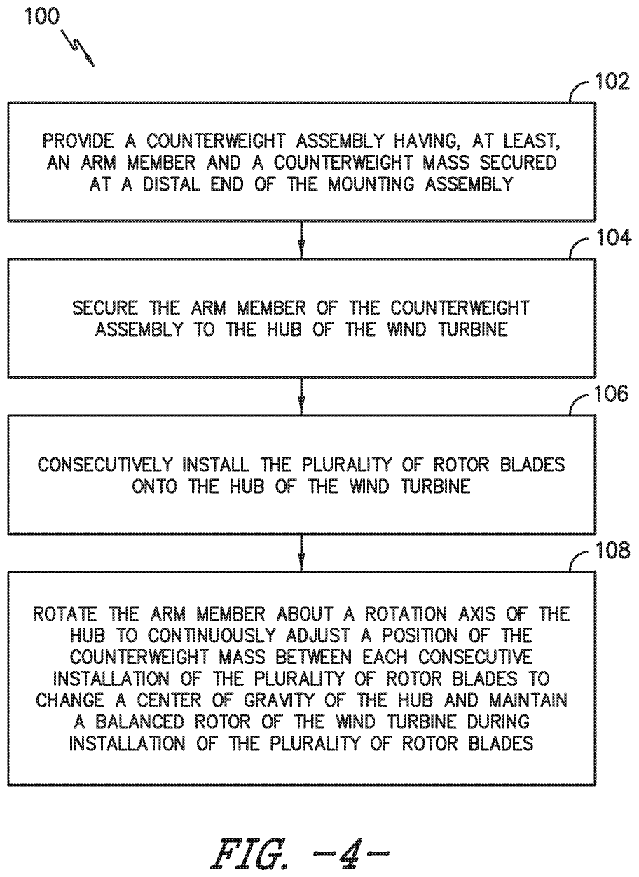

The method 100 of FIG. 4 can be better understood with respect to the various embodiments illustrated in FIGS. 5-11. More particularly, FIG. 5 illustrates a partial, perspective view of the hub 20 (i.e. without the rotor blades 22 installed thereon). Further, as shown, the counterweight assembly 80 may be installed to a front location of the hub 20. More specifically, as shown, the counterweight assembly 80 includes an arm member 84 having a proximal end secured to the hub 20 and a distal end having a counterweight mass 86 secured thereto.

In particular embodiments, the counterweight mass 86 may be a hollow mass or a solid mass. For example, in one embodiment, the solid mass may be any suitable material, including, e.g. steel. In alternative embodiments, the hollow mass may be a reservoir or tank optionally filled, at least in part, with a fluid. In such embodiments, an empty counterweight mass 86 can be easily transported to the wind turbine 10 and then subsequently filled on site to minimize shipping costs. If crane capacity allows, the counterweight mass 86 may be filled with the fluid, e.g. water, on the ground before lifting the mass uptower. In such embodiments, the amount of fluid in the reservoir may be varied to adjust a weight of the counterweight mass 86. As such, the weight of the counterweight mass 86 can be adjusted as needed based on various factors including but not limited to crane size availability, rotor blade size, tower height, rotor dimensions, etc. More specifically, as shown in FIG. 5, the amount of fluid in the reservoir may be varied by pumping in or draining out the fluid from the reservoir via at least one conduit 96 or associated piping that extends from the reservoir 86 through the arm member 84 and into the hub 20. Thus, as shown, the conduit(s) 96 may direct fluid to and from a separate storage reservoir 97 via a pump 98. In addition, as shown, the amount of the fluid pumped into and out of the reservoir may be monitored via a fill-level sight glass or a water meter (as indicated by feature 87).

Referring still to FIG. 5, one or more sensors 83 may be positioned on the arm member 84 so as to monitor a moment and/or torque exerted onto the hub 20. For example, in one embodiment, the sensor(s) 83 may be a strain gauge. In such embodiments, the sensor(s) 83 is configured to continuously monitor the actual moment and/or torque exerted onto the hub 20, i.e. zero in the 6 o'clock position and maximum in the 3- or 9 o'clock position. Accordingly, in further embodiments, the amount of fluid in the reservoir may be controlled or determined based on the moment and/or torque.

In addition, as shown in the embodiment of FIGS. 2 and 5, a slewing ring bearing 88 may be mounted to the front, exterior location of the hub 20 to provide a mounting location for the arm member 84 of the counterweight assembly 80. For example, as shown particularly in FIG. 5, the slewing ring bearing 88 may have an outer race 90 secured or affixed to the hub 20 and an inner race 92 rotatable with respect to the outer race 90 via a plurality of roller elements (not shown). As such, the arm member 84 of the counterweight assembly 80 can be mounted to the inner race 92 such that the arm member 84 can rotate with the inner race 92. Accordingly, rotation of the inner race 92 of the slewing ring bearing 88 allows for rotation of the arm member 84 and the counterweight mass 86. More specifically, in such embodiments, the inner race 92 may also include gear teeth that mesh with a drive mechanism 94 that is configured to drive rotation of the inner race 92 with respect to the outer race 90.

Still referring to FIG. 5, the counterweight mass 86 may be initially suspended in a six o'clock position. In such embodiments, the drive mechanism 94 of the slewing ring bearing 88 is configured to rotate the arm member 84 from the initial six o'clock position to any position around the inner race 92 (as indicated by the arrows in FIG. 5). In several embodiments, the counterweight mass 86 may be locked in a predetermined position via the drive mechanism 94.

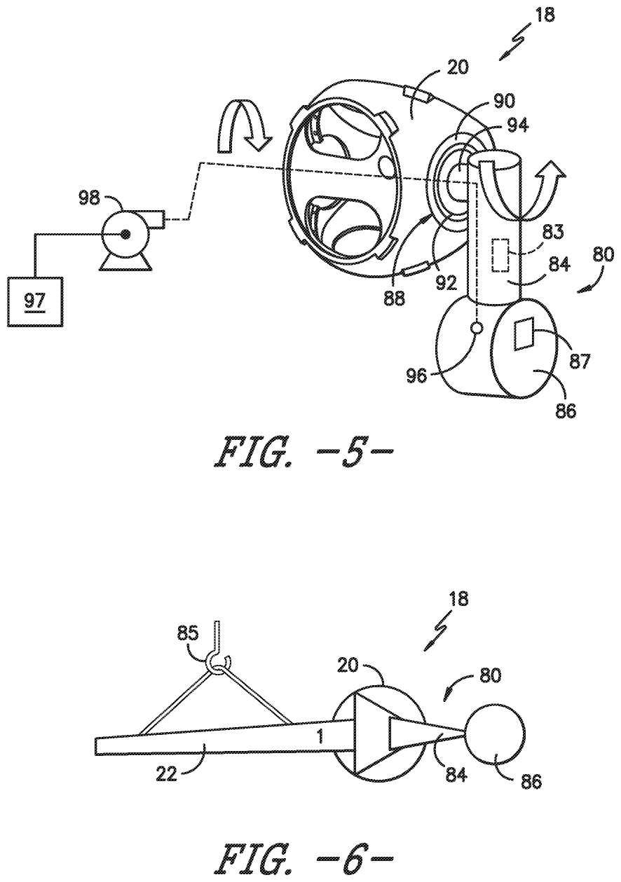

Referring now to FIG. 6, the hub 20 may be rotated such that the first pitch axis is in the 3 o'clock or 9 o'clock position. More specifically, as shown, this action can be completed by rotating the counterweight mass 86 in the opposite direction of the first pitch axis. In other words, the pendulum action of the counterweight mass 86 is configured to result in a rotation in the opposite direction. Thus, as shown, the first rotor blade 22 can be lifted uptower and installed onto the hub 20 with the counterweight mass 86 offsetting most of the torque induced by the blade weight. More specifically, as shown, a lifting device 85, such as a crane, can be used to lift each of the rotor blades 22 consecutively atop the tower 12 of the wind turbine 10.

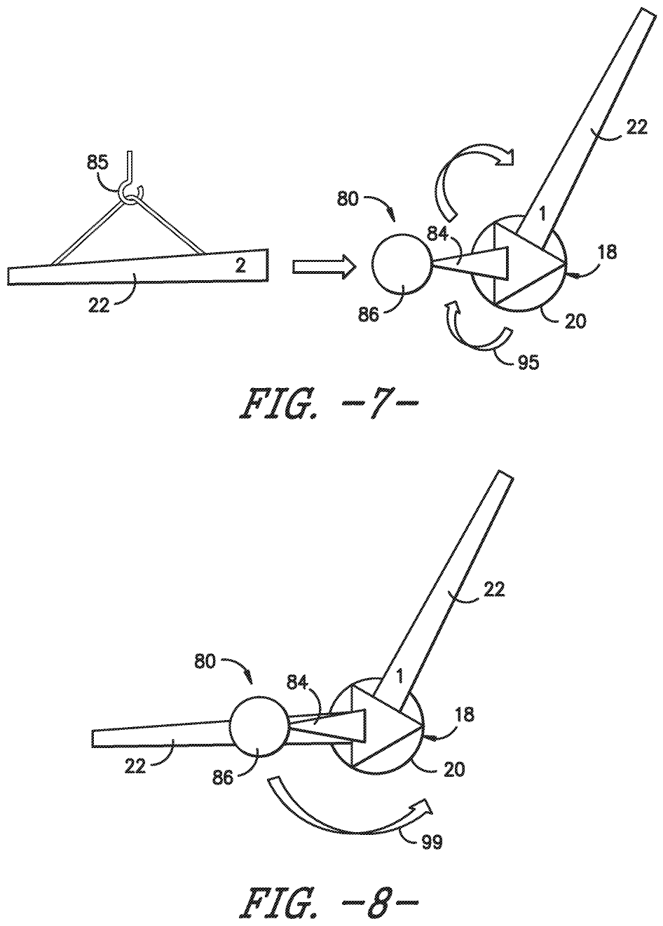

Referring now to FIG. 7, the rotor 18 can then be rotated to a second position such that a pitch axis of the second rotor blade is in the 3 o'clock or 9 o'clock position (i.e. about 120°). In such embodiments, a rotor drive mechanism 93, e.g. as shown in FIG. 2 behind the gearbox 30 may be positioned in the nacelle 16 for rotating or braking the rotor 18 during installation of the rotor blades 22. More particularly, in one embodiment, the rotor drive mechanism 93 may be an unbalanced rotor turning gear (URTG) drive. As such, the rotor drive mechanism 93 may be used to rotate the rotor 18 to the desired positions for consecutively installing each rotor blade thereto. The counterweight mass 86 can be moved simultaneously such that its resulting torque is maximized to assist the rotor drive mechanism 93, as indicated by arrow 95. In addition, as shown, the counterweight mass 86 may be rotated into the horizontal position to minimize the loads on the rotor lock. Referring back to FIG. 5, since the counterweight mass 86 is mounted to the inner race 92 of the slewing ring bearing 88 on the front of the hub 20, the mass 86 does not interfere with the installation of the second rotor blade 20. Thus, as shown in FIG. 8, the second rotor blade 22 is secured to the hub 20.

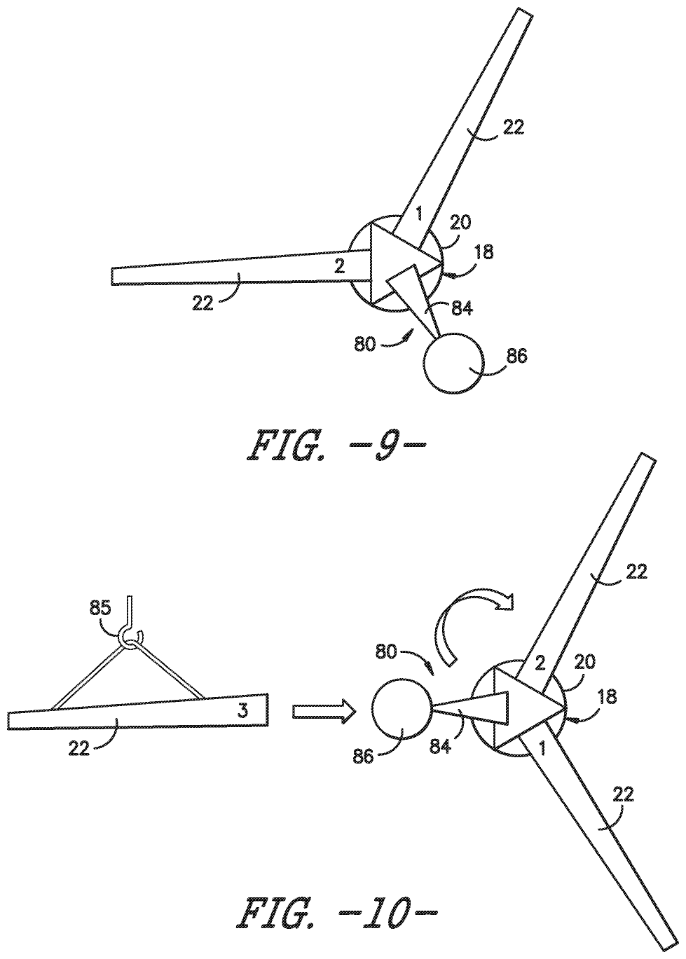

Referring now to FIG. 9, the counterweight mass 86 is again rotated simultaneously such that its resulting torque is maximized to assist the rotor drive mechanism 93, e.g. in the counterclockwise direction as indicated by the arrow 99. Thus, as shown, the counterweight mass 86 creates a substantially balanced rotor 18 even without the third rotor blade installed.

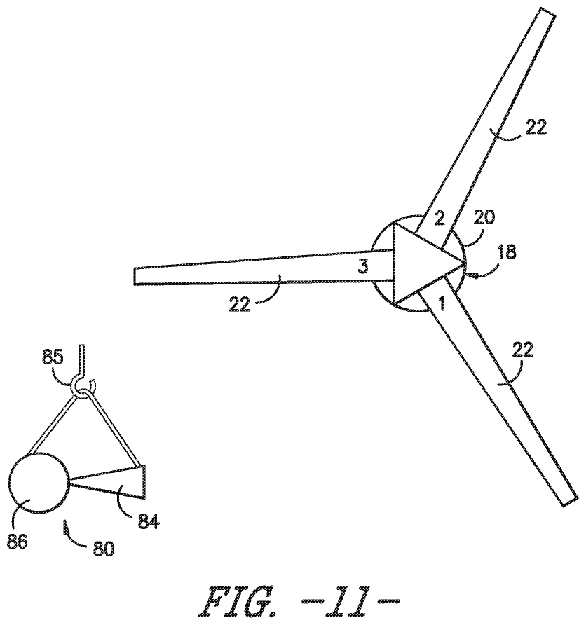

Referring now to FIG. 10, the rotor drive mechanism 93 can be used again to rotate the rotor 18 through 120°. This action should take a minimum effort due to the rotor 18 being substantially balanced. Once the rotor 18 is properly positioned, the third rotor blade 22 is installed to the hub 20. In addition, as shown in FIG. 11, the counterweight assembly 80 can then be removed and lowered to the ground, e.g. via the lifting device 85.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method for installing a plurality of rotor blades to a rotatable hub secured atop a tower of a wind turbine, the method comprising:
providing a counterweight assembly having, at least, an arm member and a counterweight mass secured at a distal end of the mounting assembly;
securing the arm member of the counterweight assembly to the hub of the wind turbine;
consecutively installing the plurality of rotor blades onto the hub of the wind turbine;
rotating the arm member about a rotation axis of the hub to continuously adjust a position of the counterweight mass between each consecutive installation of the plurality of rotor blades to change a center of gravity of the hub and maintain a balanced rotor of the wind turbine during installation of the plurality of rotor blades.

2. The method of claim 1, wherein rotating the arm member about the rotation axis of the hub to continuously adjust the position of the counterweight mass further comprises:
affixing an outer race of a slewing ring bearing to the hub and allowing an inner race of the slewing ring bearing to rotate with respect to the outer race; and,
mounting the arm member to the inner race of the slewing ring bearing, wherein rotation of the inner race of the slewing ring bearing allows for rotation of the arm member and the counterweight mass.

3. The method of claim 2, further comprising affixing the outer race of the slewing ring bearing to a front, exterior location of the hub.

4. The method of claim 2, wherein the inner race of the slewing ring bearing further comprises gear teeth that mesh with a drive mechanism, the drive mechanism configured to drive rotation of the inner race with respect to the outer race.

5. The method of claim 4, wherein the counterweight mass is initially suspended in a six o'clock position.

6. The method of claim 5, wherein the drive mechanism is configured to rotate the arm member from the six o'clock position to any position around the inner race of the slewing ring bearing.

7. The method of claim 4, further comprising locking the counterweight mass in a predetermined position via the drive mechanism.

8. The method of claim 1, wherein the counterweight mass comprises, at least in part, a reservoir filled at least partially with a fluid.

9. The method of claim 8, further comprising varying an amount of the fluid in the reservoir to vary a weight of the counterweight mass by pumping in or draining out the fluid from the reservoir via at least one conduit that extends from the reservoir through the arm member and into the hub.

10. The method of claim 9, further comprising monitoring a moment and/or torque exerted onto the hub via at least one sensor mounted on the arm member and controlling the amount of fluid in the reservoir based on the moment and/or torque.

11. The method of claim 9, further comprising monitoring the amount of the fluid pumped into the reservoir via at least one of a fill-level sight glass or a water meter.

12. A counterweight assembly for maintaining balance of a rotor of a wind turbine during installation of a plurality of rotor blades onto a rotatable hub secured atop a tower of the wind turbine, the counterweight assembly comprising:
a counterweight mass configured to be moved to multiple positions between consecutive installations of the plurality of rotor blades to continuously change a center of gravity of the hub and maintain balance of the rotor during installation of the plurality of rotor blades; and,
a rotatable arm member comprising a proximal end and a distal end, the counterweight mass secured at the distal end such that, when the arm member is secured to the hub, the counterweight mass remains spaced apart a predetermined distance from the hub, the proximal end configured for affixing the arm member at a front, exterior location of the hub forward of the plurality of rotor blades,
wherein the rotatable arm member is configured to rotate about a rotation axis of the hub to continuously adjust a position of the counterweight mass between consecutive installations of the plurality of rotor blades to change a center of gravity of the hub and maintain a balanced rotor of the wind turbine during installation of the plurality of rotor blades.

13. The counterweight assembly of claim 12, further comprising a slewing ring bearing mounted at the front, exterior location of the hub, the slewing ring bearing comprising an outer race and an inner race rotatable with respect to the outer race, the proximal end of the arm member being affixed to the inner race, wherein rotation of the inner race allows for rotation of the arm member and the counterweight mass.

14. The counterweight assembly of claim 13, wherein the inner race of the slewing ring bearing further comprises gear teeth that mesh with a drive mechanism, the drive mechanism configured to drive rotation of the inner race with respect to the outer race.

15. The counterweight assembly of claim 14, wherein the counterweight mass is initially suspended in a six o'clock position before the plurality of rotor blades are installed onto the hub.

16. The counterweight assembly of claim 15, wherein the drive mechanism is configured to rotate the arm member from the six o'clock position to any position around the inner race of the slewing ring bearing.

17. The counterweight assembly of claim 12, wherein the counterweight mass comprises at least one of a solid mass or a hollow mass.

18. The counterweight assembly of claim 17, wherein the hollow mass comprises a reservoir at least partially filled with a fluid.

19. The counterweight assembly of claim 17, further comprising at least one pump and associated piping for varying an amount of the fluid in the reservoir so as to vary a weight of the counterweight mass, the associated piping comprising at least one conduit that extends from the reservoir through the arm member and into the hub.

20. The counterweight assembly of claim 12, further comprising a lifting device for lifting each of the plurality of rotor blades consecutively atop the tower of the wind turbine.
